(19) United States
(12) Patent Application Publication
(10) Pub. No.: US 2018/0194419 A1
(43) Pub. Date: Jul. 12, 2018

(54) AERODYNAMIC BOTTLE HOLDER SYSTEM

(71) Applicant: KQS INC., Ontario (CA)

(72) Inventors: Kevin QUAN, Ontario (CA); Michael BAKAIC, Ontario (CA); Sebastian TYMOCZKO, Ontario (CA)

(21) Appl. No.: 15/740,324

(22) PCT Filed: Jun. 23, 2016
(86) PCT No.: PCT/IB2016/053747

§ 371 Date: Dec. 27, 2017

Related U.S. Application Data
(60) Provisional application No. 62/188,466, filed on Jul. 2, 2015.

(51) Int. Cl. B62J 11/00

(52) U.S. Cl. CPC B62J 11/00; B62K 19/40

(57) ABSTRACT

A bottle holder system mountable to a bicycle (10), wherein said bicycle comprises a down tube (18) and a seat tube (20), wherein said bottle holder system comprises: a first bottle holder (100) comprising (i) a first bottom wall (104) mountable to a rear side of the down tube, (ii) a first left side wall (106), and (iii) a first right side wall (108) all forming a first interior cavity (110) shaped for receiving a first round bottle (112); a second bottle holder (200) comprising (i) a second bottom wall (204) mountable to a front side of the seat tube, (ii) a second left side wall (206), and (iii) a second right side wall (208) all forming a second interior cavity (210) shaped for receiving a second round bottle (212); wherein the down tube, the seat tube and exterior surfaces of said first left side wall, second left side wall, first right side wall and second right side wall cooperate to form an airfoil shape (500).

### FIELD OF THE INVENTION

The present invention relates to bottle holders, and more specifically, to bottle holders mountable to bicycles.

### BACKGROUND

It is known to mount bottle holders or bottle cages to bicycles. Such bottle holders or cages are typically mounted to the rear side of the down tube of a bicycle. The bottle holder or cage is often made up of a metal wire frame that is sized and shaped so as to receive and hold a standard round water bottle having a diameter of about 73 mm. When a cyclist is riding his or her bicycle and desires to hydrate themselves, he or she reaches downwards with one hand and takes the water bottle out of the bottle holder or cage. This is particularly important to professional and amateur cycling athletes who often need to consume about 8 or more bottles of water per racing day.

One limitation in using the standard bottle holder or cage is that it creates high aerodynamic drag. As the bicycle is travelling forward, air passes around the down tube, and when the air hits the standard bottle holder or cage, the round shapes of the bottle holder or cage and the water bottle result in significant air resistance or drag. The air drag acts opposite to the forward motion of the bicycle, thus reducing the velocity of the bicycle. This is particularly important to professional and amateur cycling athletes where small advantages in aerodynamics can change the results of a cycling race.

It has been suggested to reduce air drag by using a combination of an airfoil shaped water bottle and a bottle holder or cage that is shaped to receive this bottle. An airfoil typically has a rounded leading edge followed by a sharp trailing edge. The airfoil shape, similar to that of an airplane wing or a keel on a boat, results in a lower aerodynamic drag than the round shapes of the standard bottle holder or cage and the standard round water bottles.

However, cyclists have found the airfoil shaped water bottle to be difficult to use. In particular, the unusual shape of the water bottle makes it awkward for the cyclist to hold in his or her hand and to drink from while riding. Cyclists are accustomed to using standard round water bottles and prefer to hold and drink from these standard round water bottles.

Furthermore, while racing, professional and amateur cycling athletes need to quickly and easily replace an empty water bottle with a new water bottle. Specifically, the cyclist must: (i) easily remove an empty water bottle from the bottle holder or cage and dispose of it; and (ii) pick up a new water bottle, which may be handed to the cyclist by another person at a water station or in a moving vehicle, and put it into the bottle holder or cage. Preferably, this is done while the bicycle is still travelling forward so that the cyclist does not need to stop and lose time in his or her race. It has been found that the airfoil shaped bottle is not preferred for replacing empty bottles with new bottles. The unusual shape of the airfoil shaped bottle makes it awkward to remove from the bottle holder or cage and to put the bottle into the bottle holder or cage. This is particularly difficult to do while the bicycle is still travelling forward, especially at high velocities.

It would be advantageous for the bottle holder mounted to the bicycle to be configured into a system which produces relatively low air drag while the bicycle is travelling forward.

It would also be advantageous for such a system to be configured so that cyclists can use standard round water bottles which they are accustomed to holding, drinking from and replacing.

It would also be advantageous for such a system to allow the bicycle to carry a larger quantity of water so that the cyclist does not need to replace empty bottles as often.

### SUMMARY OF THE INVENTION

In one aspect, the present invention provides a bottle holder system mountable to a bicycle, wherein said bicycle comprises a down tube and a seat tube, wherein said system comprises: a first bottle holder, said first bottle holder comprising: (i) a first bottom wall; (ii) a first left side wall extending from said first bottom wall; and (iii) a first right side wall extending from said first bottom wall, wherein said first bottom wall is mountable to a rear side of the down tube of the bicycle, and wherein said first bottom wall, first left side wall and first right side wall form a first interior cavity shaped for receiving a first round bottle; a second bottle holder, said second bottle holder comprising: (i) a second bottom wall; (ii) a second left side wall extending from said second bottom wall; and (iii) a second right side wall extending from said second bottom wall, wherein said second bottom wall is mountable to a front side of the seat tube of the bicycle, and wherein said second bottom wall, second left side wall and second right side wall form a second interior cavity shaped for receiving a second round bottle; wherein the down tube, the seat tube and exterior surfaces of said first left side wall, second left side wall, first right side wall and second right side wall cooperate to form an airfoil shape, wherein: (i) the down tube is a leading edge of the airfoil shape; (ii) the seat tube is a trailing edge of the airfoil shape; (iii) the exterior surfaces of the first left side wall and the second left side wall comprise a left side of the airfoil shape; and (iv) the exterior surfaces of the first right side wall and the second right side wall comprise a right side of the airfoil shape.

In another aspect, the present invention provides a method for reducing air drag acting against a forward motion of a bicycle, said method comprising providing the bottle holder system of the present invention mountable to said bicycle, wherein said bicycle comprises a down tube and a seat tube, wherein said system comprises: a first bottle holder, said first bottle holder comprising: (i) a first bottom wall; (ii) a first left side wall extending from said first bottom wall; and (iii) a first right side wall extending from said first bottom wall, wherein said first bottom wall is mountable to a rear side of the down tube of the bicycle, and wherein said first bottom wall, first left side wall and first right side wall form a first interior cavity shaped for receiving a first round bottle; a second bottle holder, said second bottle holder comprising: (i) a second bottom wall; (ii) a second left side wall extending from said second bottom wall; and (iii) a second right side wall extending from said second bottom wall, wherein said second bottom wall is mountable to a front side of the seat tube of the bicycle, and wherein said second bottom wall, second left side wall and second right side wall form a second interior cavity shaped for receiving a second round bottle; wherein the down tube, the seat tube and exterior surfaces of said first left side wall, second left side wall, first right side wall and second right side wall cooperate to form an airfoil shape, wherein: (i) the down tube is a leading edge of the airfoil shape; (ii) the seat tube is a trailing edge of the airfoil shape; (iii) the exterior surfaces of the first left side wall and the second left side wall comprise a left side of the airfoil shape; and (iv) the exterior surfaces of the first right side wall and the second right side wall comprise a right side of the airfoil shape.

Preferably, at least a portion of the exterior surface of the first left side wall and at least a portion of the exterior surface of the second left side wall form a substantially continuous left surface over which air flows without going in between the first left side wall and the second left side wall.

Preferably, at least a portion of the exterior surface of the first right side wall and at least a portion of the exterior surface of the second right side wall form a substantially continuous right surface over which air flows without going in between the first right side wall and the second right side wall.

In one preferred embodiment, lower sections of the second left side wall and the second right side wall of the second bottle holder are nested within lower sections of the first left side wall and the first right side wall of the first bottle holder.

In another preferred embodiment, lower sections of the first left side wall and the first right side wall of the first bottle holder are nested within lower sections of the second left side wall and the second right side wall of the second bottle holder.

Preferably, said first bottle holder further comprises one or more ridges extending into the first interior cavity for securing the first round bottle in position.

Preferably, said second bottle holder further comprises one or more ridges extending into the second interior cavity for securing the second round bottle in position.

Preferably, said first bottle holder and said second bottle holder comprise a solid material selected from the group consisting of metal, plastic and carbon fiber.

### BRIEF DESCRIPTION OF THE DRAWINGS

FIG. 1 illustrates a perspective view of a preferred embodiment of the bottle holder system of the present invention mounted to a bicycle;

FIG. 2 illustrates a side view of the preferred embodiment of FIG. 1;

FIG. 3 illustrates a top cross sectional view of the preferred embodiment of FIG. 1;

FIG. 4 illustrates a rear view of a preferred embodiment of a first bottle holder of the system of the present invention, wherein the first bottle holder is mountable to a down tube of a bicycle;

FIG. 5 illustrates a side view of the preferred embodiment of FIG. 4;

FIG. 6 illustrates a top view of the preferred embodiment of FIG. 4;

FIG. 7 illustrates a rear view of a preferred embodiment of a second bottle holder of the system of the present invention, wherein the second bottle holder is mountable to a seat tube of a bicycle;

FIG. 8 illustrates a side view of the preferred embodiment of FIG. 7;

FIG. 9 illustrates a top view of the preferred embodiment of FIG. 7;

FIG. 10 illustrates a side view of a preferred embodiment of the bottle holder system of the present invention mounted to a bicycle with a wind plane drawn across the bottle holder system;

FIG. 11 is a sectional view of the preferred embodiment of FIG. 10 including the wind plane drawn across the bottle holder system;

FIG. 12 illustrates a top sectional view of a down tube, first bottle, second bottle and seat tube with an air flow going directly parallel to these components;

FIG. 13 illustrates a top sectional view of a down tube, first bottle, second bottle and seat tube with an air flow coming into contact with these components at an angle;

FIG. 14 illustrates a top sectional view of a preferred embodiment of the bottle holder system of the present invention with an air flow going parallel to this preferred embodiment;

FIG. 15 illustrates a top sectional view of the preferred embodiment of FIG. 14 with an air flow coming into contact with this preferred embodiment at an angle; and

FIG. 16 is a graph illustrating the results of a wind tunnel test conducted on a preferred embodiment of the bottle holder system of the present invention.

### DETAILED DESCRIPTION OF THE PREFERRED EMBODIMENTS

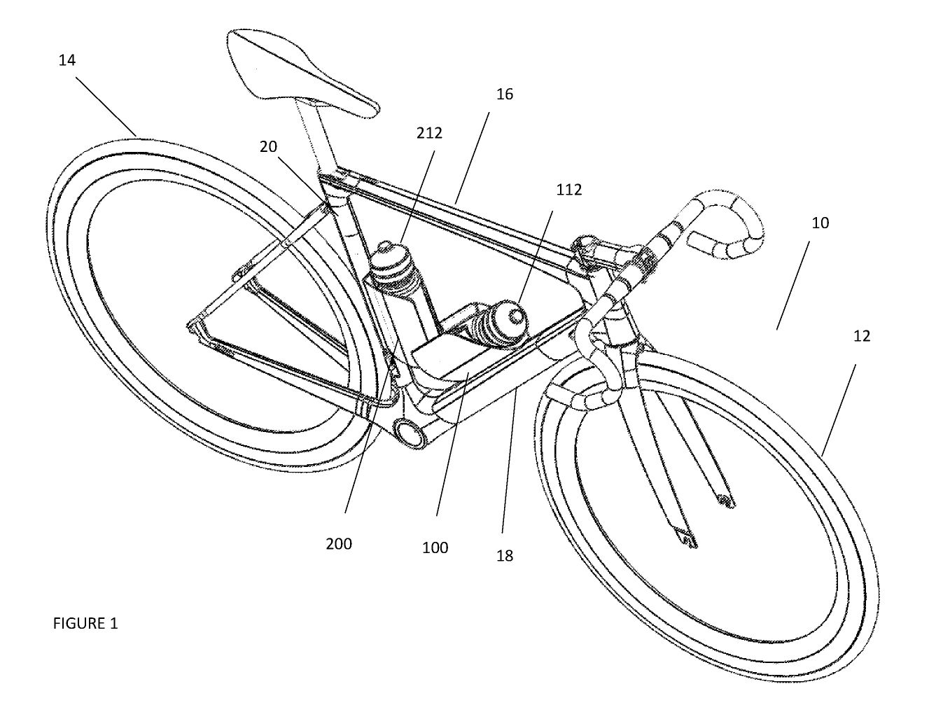

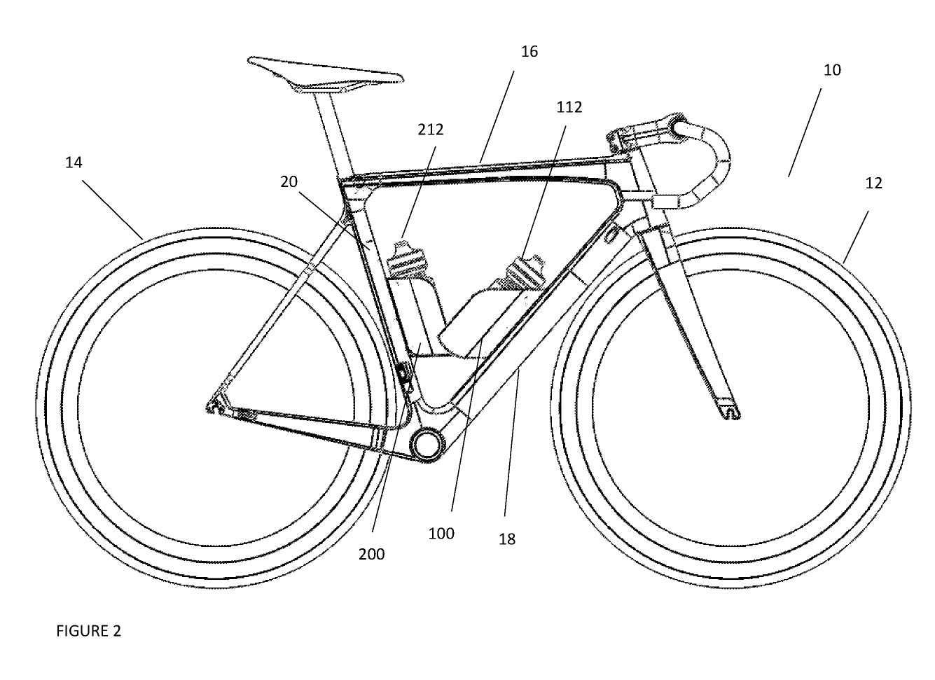

FIGS. 1 and 2 show a preferred embodiment of the bottle holder system of the present invention when mounted to a bicycle. A standard bicycle 10 has a front wheel 12 and a rear wheel 14. The frame of the standard bicycle 10 includes a top tube 16, a down tube 18 and a seat tube 20, connected to each other and generally forming a triangular shape between the front wheel 12 and the rear wheel 14.

The preferred system of the present invention comprises a first bottle holder 100 and a second bottle holder 200. The first bottle holder 100 is mounted to the rear side of the down tube 18 of the bicycle 10. The second bottle holder 200 is mounted to the front side of the seat tube 20 of the bicycle 10.

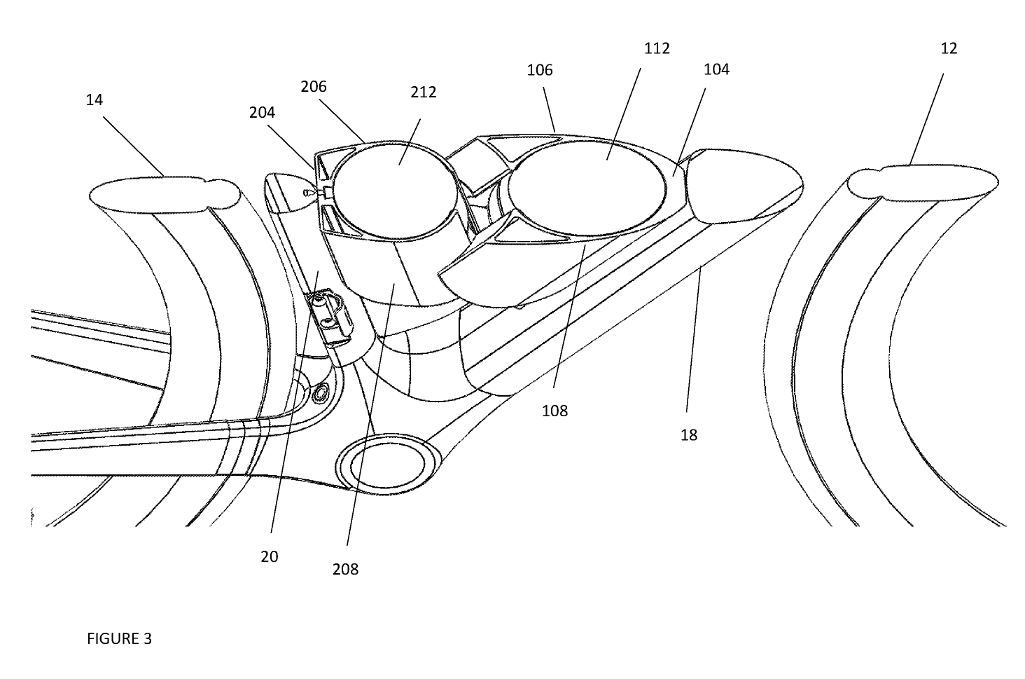

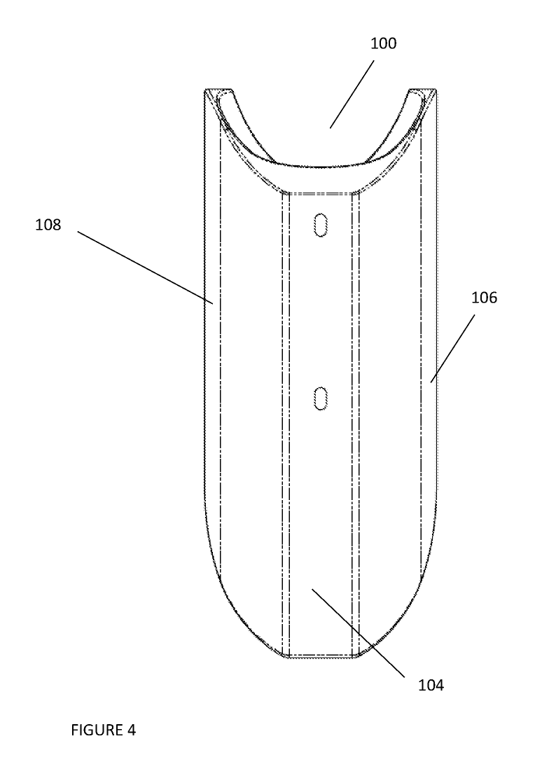

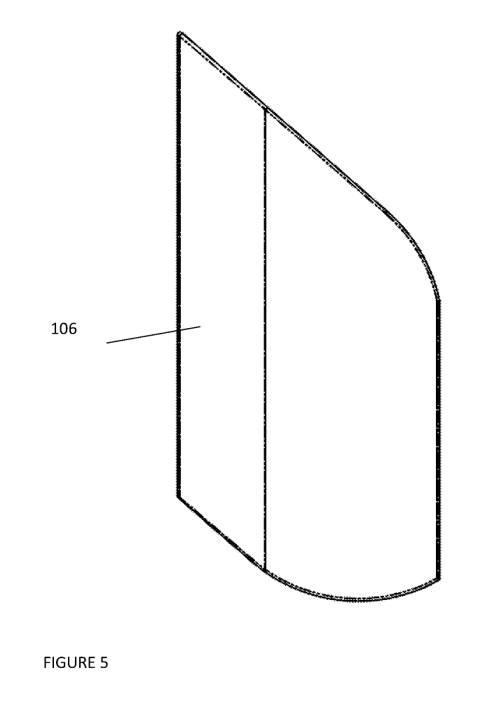

A preferred embodiment of the first bottle holder is shown in FIGS. 3 to 6. The first bottle holder 100 comprises: (i) a first bottom wall 104; (ii) a first left side wall 106 extending from said first bottom wall 104; and (iii) a first right side wall 108 extending from said first bottom wall 104.

The first bottom wall 104, first left side wall 106 and first right side wall 108 together form a first interior cavity 110 shaped for receiving a first round bottle 112. In particular, the interior surfaces of the first bottom wall 104, first left side wall 106 and first right side wall 108 are curved so that they together form a round first interior cavity 110 which is generally shaped to receive and hold a standard round water bottle 112. Preferably, the first interior cavity 110 is sized to receive and hold standard round water bottles which have a diameter of about 73 mm.

The first bottom wall 104 is mounted to a rear side of the down tube 18 of the bicycle 10, as shown in FIGS. 1 to 3. It may be mounted by any means, such as but not limited to using fasteners, such as screws and rivets, and welding.

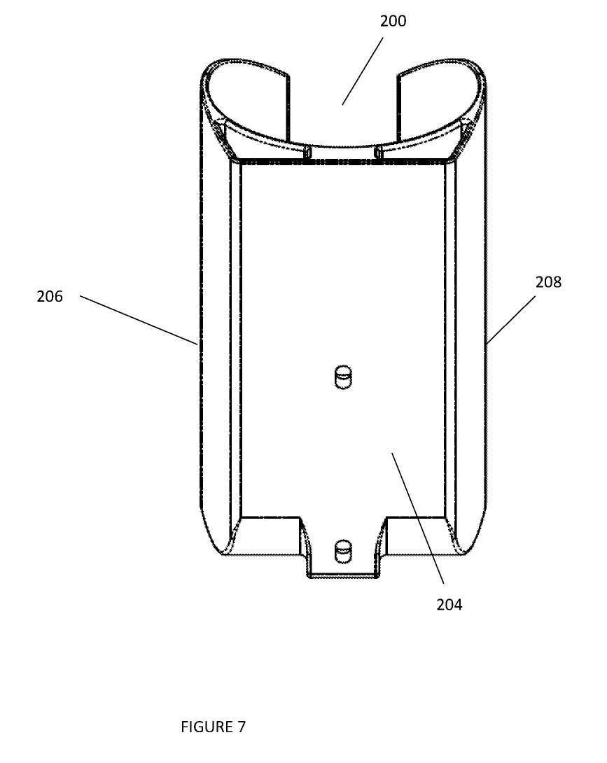

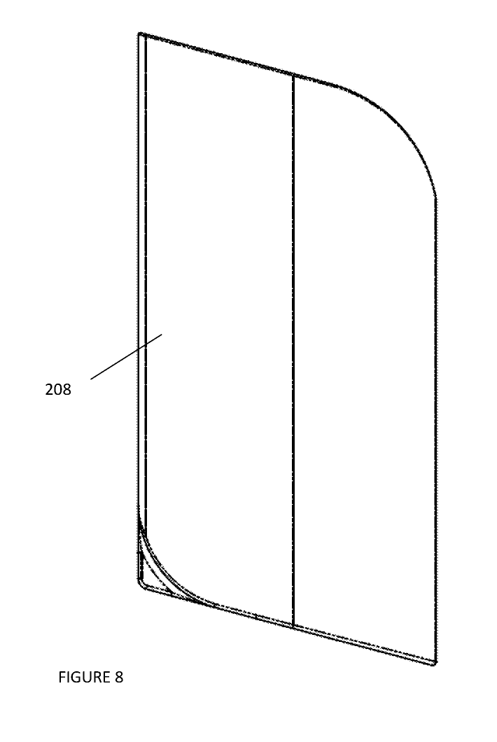

A preferred embodiment of the second bottle holder 200 is shown in FIGS. 3 and 7 to 9. The second bottle holder 200 comprises: (i) a second bottom wall 204; (ii) a second left side wall 206 extending from said second bottom wall 204; and (iii) a second right side wall 208 extending from said second bottom wall 204.

The second bottom wall 204, second left side wall 206 and second right side wall 208 together form a second interior cavity 210 shaped for receiving a second round bottle 212. In particular, the interior surfaces of the second bottom wall 204, second left side wall 206 and second right side wall 208 are curved so that they together form a round second interior cavity 210 which is generally shaped to receive and hold a standard round water bottle 212. Preferably, the second interior cavity 210 is also sized to receive and hold standard round water bottles which have a diameter of about 70 mm.

The second bottom wall 204 is mounted to a front side of the seat tube 20 of the bicycle, as shown in FIGS. 1 to 3. It may also be mounted by any means, such as but not limited to using fasteners, such as screws and rivets, and welding.

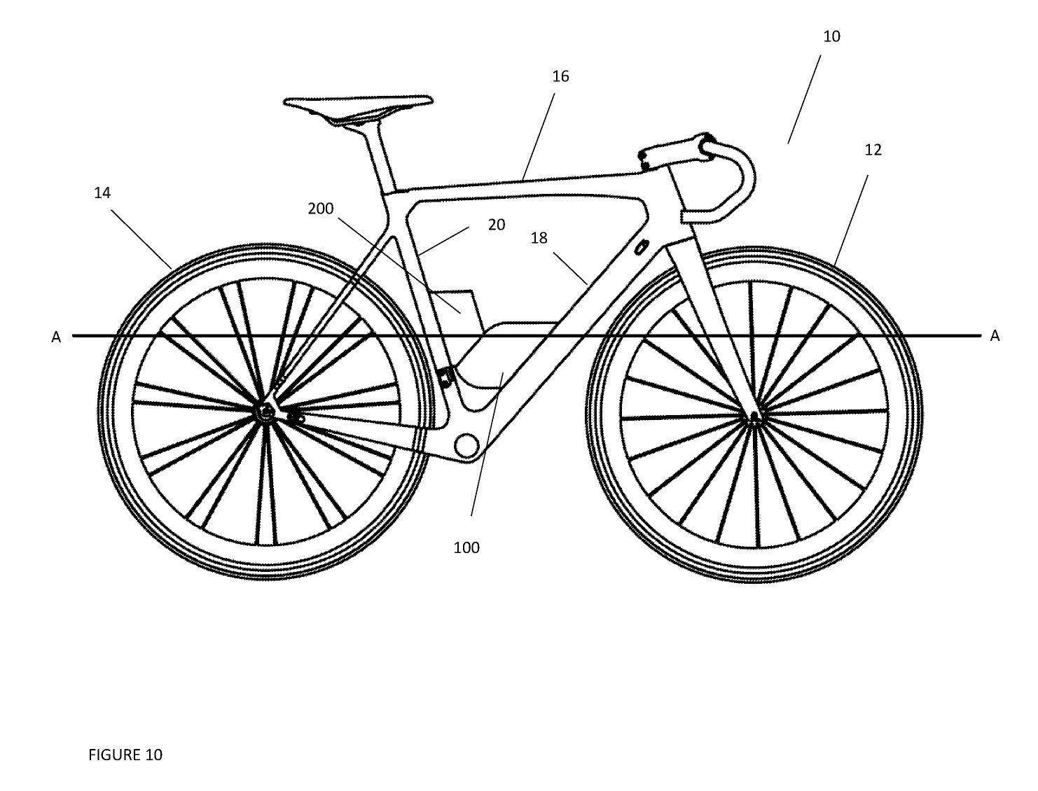

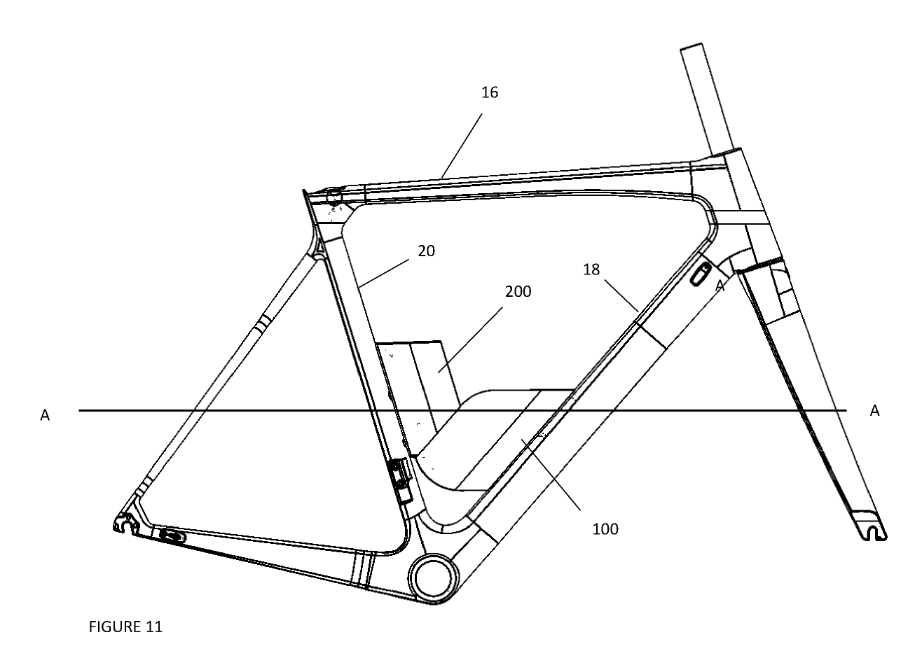

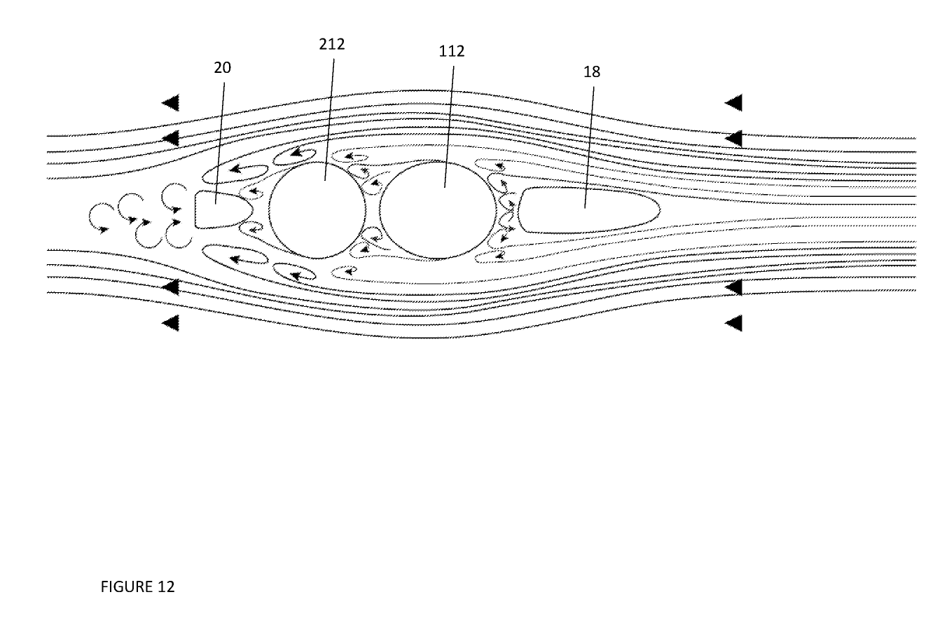

FIGS. 10 and 11 show a preferred embodiment of the bottle holder system of the present invention mounted to a bicycle 10. A wind plane is shown by the line A-A. As the bicycle 10 travels forward, air flows along wind plane A-A from the front wheel 12 to the rear wheel 14, and slows down the forward progress of the bicycle 10. FIGS. 12 to 15 illustrate a variety of different air flows along wind plane A-A.

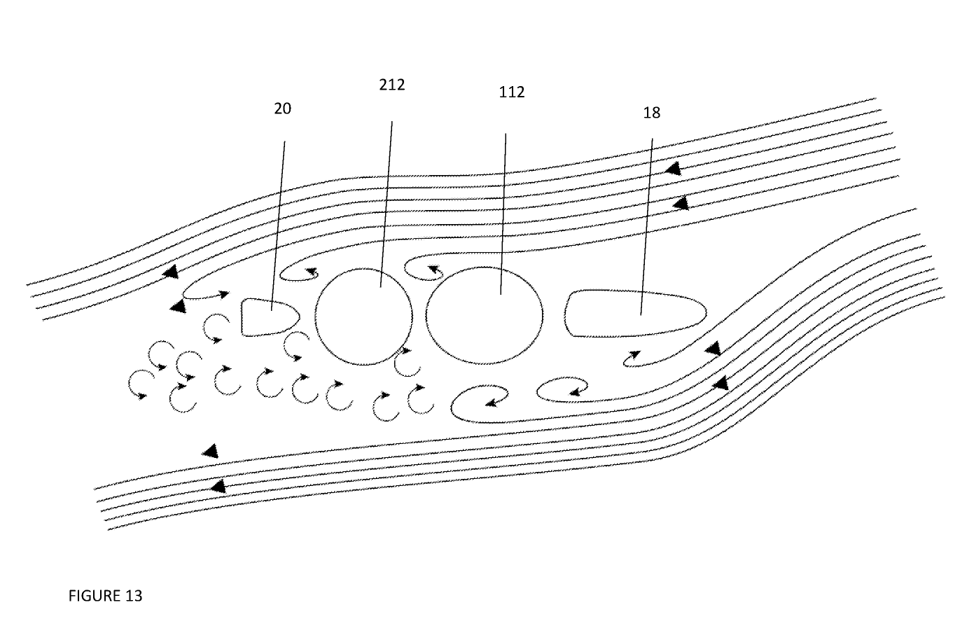

FIGS. 12 and 13 show an air flow where the bicycle 10 does not have the bottle holder system of the present invention. In FIG. 12, the air travels generally parallel to the bicycle. More specifically, the air travels generally parallel in a direction going through the down tube 18, the first bottle 112, the second bottle 212 and the seat tube 20. As can be seen in FIG. 12, this configuration leads to a turbulent air flow with a significant amount of air resistance against the forward travel of the bicycle 10. Great amounts of resistance can be seen in the areas: (i) between the down tube 18 and the first bottle 112; (ii) between the first bottle 112 and the second bottle 212; (iii) between the second bottle 212 and the seat tube 20; and (iv) behind the seat tube 20. Such air resistance slows down the forward progress of the bicycle 10 and can lead to significant time being lost in a race.

In FIG. 13, the air travels at an angle to the direction going through the down tube 18, the first bottle 112, the second bottle 212 and the seat tube 20. This scenario also produces a turbulent air flow with a significant amount of air resistance against the forward travel of the bicycle 10. In this case, much of the air resistance accumulates to the right and behind each of the down tube 18, the first bottle 112, the second bottle 212 and the seat tube 20. Again, this amount of air resistance is not preferred and can lead to significant time being lost in a race.

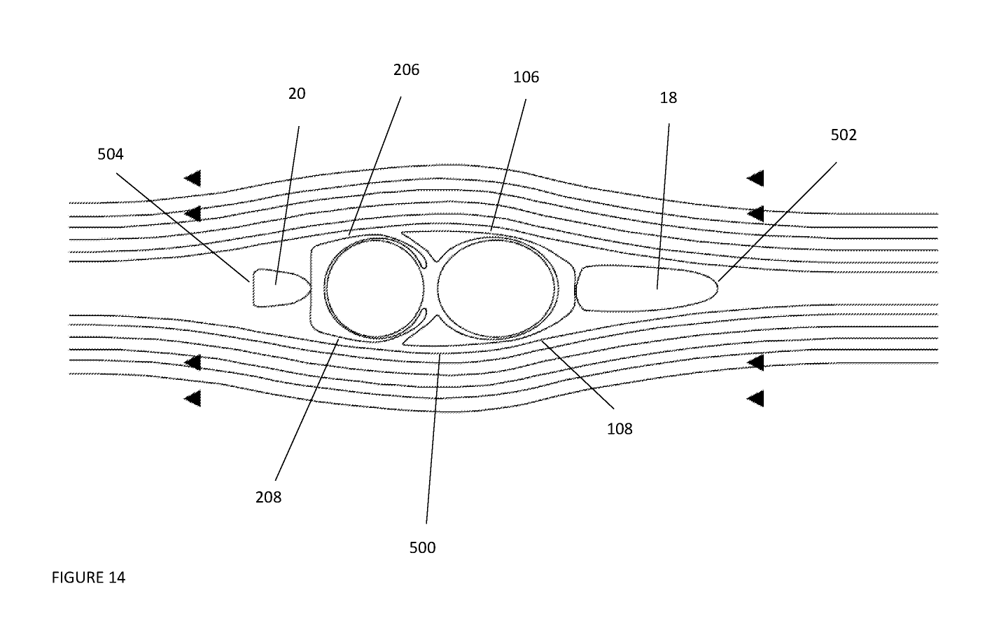

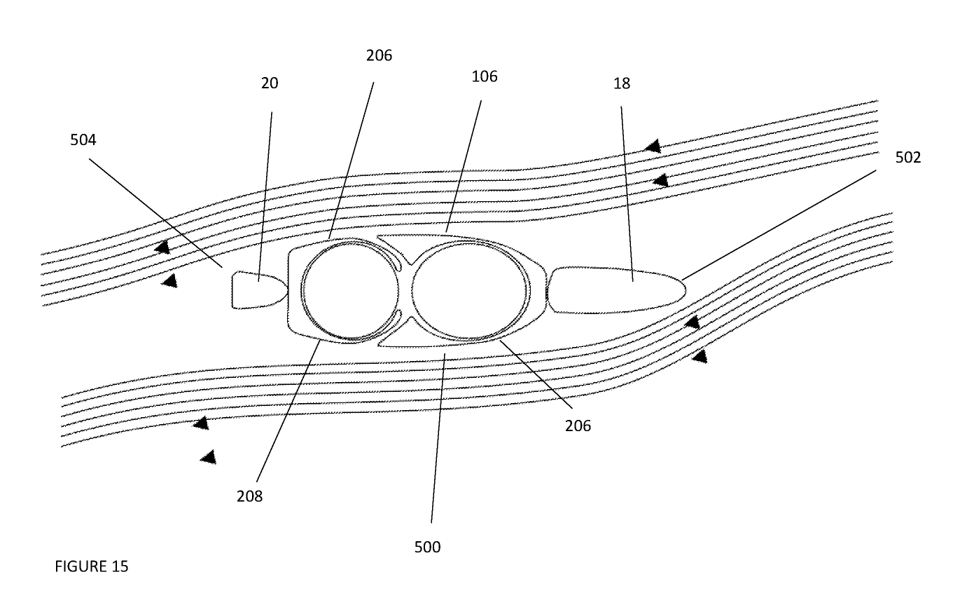

As illustrated in FIGS. 14 and 15, the down tube 18, first left side wall 106 and first right side wall 108 together form the front portion of an airfoil 500. The exterior surfaces of the first left side wall 106 and the first right side wall 108 are slightly curved. The down tube 18 serves as the leading edge 502 of the air foil 500. When the bicycle travels forward, air flows around this leading edge 502 to the exterior surfaces of the first left side wall 106 and the first right side wall 108.

Also as illustrated in FIGS. 14 and 15, the seat tube 20, second left side wall 206 and second right side wall 208 together form the rear portion of the airfoil 500. The exterior surfaces of the second left side wall 206 and the second right side wall 208 are slightly curved. The seat tube 20 serves as the trailing edge 504 of the air foil 500. Air flows from the exterior surfaces of the first left side wall 106 and the first right side wall 108 to the exterior surfaces of the second left side wall 206 and the second right side wall 208, respectively. Subsequently, air passes around the trailing edge 504 of the airfoil 500.

The airfoil 500 reduces aerodynamic drag on the bicycle, similar to other airfoils such as the bodies of many fish or the keels on boats. The system's air foil shape can be seen in the views presented by FIGS. 14 and 15. When the bicycle is in forward motion, air flows around the leading edge 502 formed by the down tube 18 to the slightly curved exterior surfaces of the first left side wall 106 and the first right side wall 108. Air then flows to the slightly curved exterior surfaces of the second left side wall 206 and the second right side wall 208. Finally, air flows around the trailing edge 504 formed by the seat tube 20. The above mentioned components are in close proximity to each other, thus forming a continuous or mostly continuous air foil shape through which air travels smoothly and avoids separation. As a result, a more laminar air flow is produced and air drag which opposes the forward motion of the bicycle 10 is significantly reduced. This occurs in cases where the air flow is parallel to the forward direction of the bicycle 10 and to the airfoil 500 formed by the components of the bottle holder system, as in FIG. 14, and where the air flow is at an angle to the forward motion of the bicycle 10 and to the airfoil 500 formed by the components of the bottle holder system, as in FIG. 15.

In the preferred embodiment shown in FIGS. 1 to 3, lower sections of the second left side wall 206 and the second right side wall 208 of the second bottle holder 200 are nested within lower sections of the first left side wall 106 and the first right side wall 108 of the first bottle holder 100. The side walls 106, 108 of the first bottle holder 100 are spread out further apart than the side walls 206, 208 of the second bottle holder 200 and are shaped so as to receive the side walls 206, 208 of the second bottle holder 200. This allows the first bottle holder 100 and the second bottle holder 200 to be in relatively close proximity to each other. Because of this close proximity, at least portions of the exterior surfaces of the first left side wall 106 and the second left side wall 206 are continuous or mostly continuous with each other. Similarly, at least portions of the exterior surfaces of the first right side wall 108 and the second right side wall 208 are continuous or mostly continuous with each other. Therefore, when air passes from the exterior surfaces of the side walls 106, 108 of the first bottle holder 100 to the exterior surfaces of the side walls 206, 208 of the second bottle holder 200, it flows smoothly through the air foil 500 with little separation and flow between the side walls. This reduces air drag on the bicycle 10 and results in less opposition to the forward motion of the bicycle 10.

The first bottle holder 100 and the second bottle holder 200 are configured to receive and hold standard round water bottles 112, 212. Cyclists prefer using standard round water bottles 112, 212 over air foil shaped water bottles since they are relatively easy to hold and drink from, especially when the bicycle is in motion. Furthermore, the standard round water bottles 112, 212 are preferred by cyclists over air foil shaped water bottles because it is easier to remove empty round water bottles 112, 212 from the bottle holders 100, 200 and it is easier to place new round water bottles 112, 212 into the bottle holders 100, 200, particularly when the bicycle 10 is in motion.

In addition, the system of the present invention allows for the bicycle 10 to carry two bottles 112, 212 instead of one. As a result, the cyclist does not need to replace empty water bottles as frequently. This may be a significant advantage in a race where the replacement of empty water bottles causes the cyclist to reduce speed and sometimes stop altogether.

The first bottle holder 100 and the second bottle holder 200 may be made from any suitable solid material, such as but not limited to metal, plastic and carbon fiber.

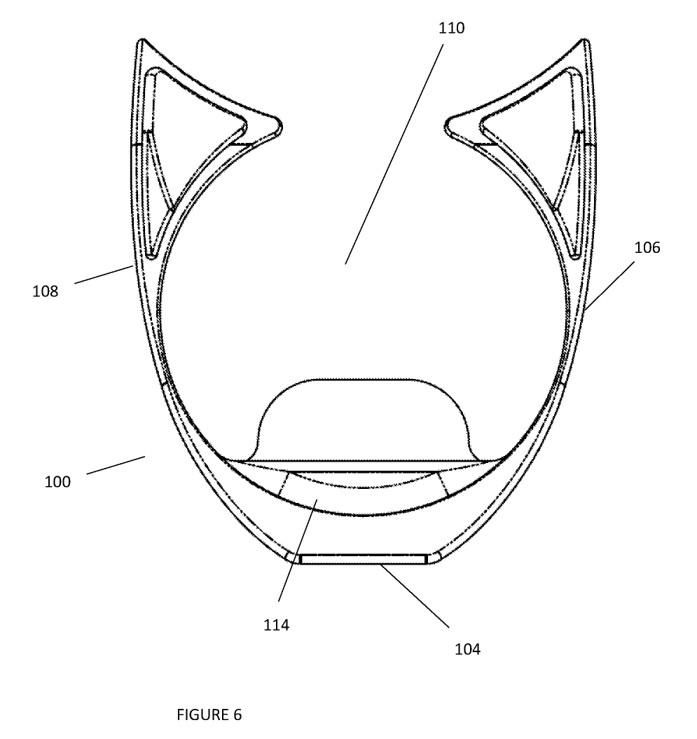

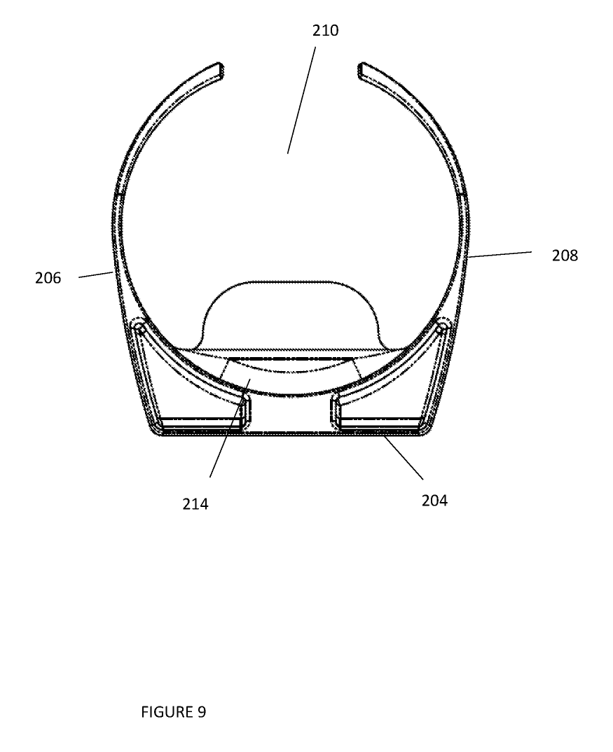

As shown in FIGS. 6 and 9, the first bottle holder 100 and the second bottle holder 200 further comprise ridges 114, 214 which extend: (i) from the first bottom wall 104 into the first interior cavity 110; and (ii) from the second bottom wall 204 into the second interior cavity 210. These ridges 114, 214 help to further secure the water bottles 112, 212 held in the first bottle holder 100 and the second bottle holder 200.

### Example 1

Wind tunnel tests were conducted to evaluate the effect of a preferred embodiment of the bottle holder system of the present invention on reducing air drag on a bicycle. The following three configurations were tested and compared to each other:

1. A bicycle which does not have any bottle holders or cages mounted to it. Hence, no water bottles were mounted to the bicycle.
2. A bicycle with two conventional bottle cages mounted to the bicycle, with one cage mounted to the rear side of the down tube and one cage mounted to the front side of the seat tube. Two standard round water bottles were mounted to the bicycle, with one bottle being held in each cage.
3. A bicycle with a preferred embodiment of the bottle holder system of the present invention mounted to it. Two standard round water bottles were mounted to the bicycle, with one bottle held in the first bottle holder and the other bottle held in the second bottle holder.

Each of the above configurations was tested in the wind tunnel, where wind is blown towards the bicycle. The tests were conducted at the following wind angles, namely the angle at which the wind strikes the bicycle relative to the plane extending from the front wheel to the rear wheel when the bicycle is in forward motion:

(a) 0 degrees (ie. parallel to the plane extending from the front wheel to the rear wheel).
(b) 5 degrees.
(c) 10 degrees.
(d) 15 degrees.
(e) 20 degrees.

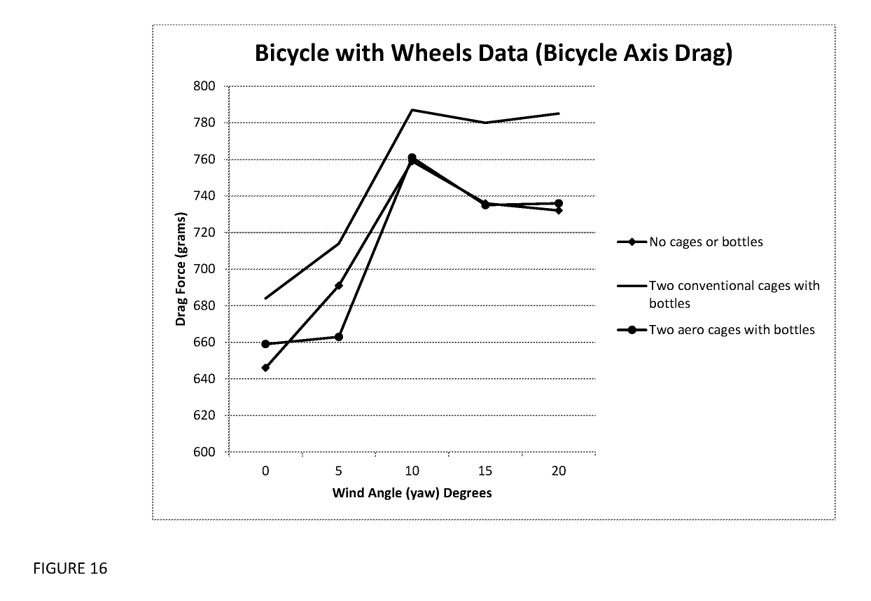

The drag force was measured for each of the above-mentioned configurations at each of the above-mentioned wind angles. Results of the tests are shown in FIG. 16.

As shown in FIG. 16, there was significantly higher drag force for each of the five wind angles tested when there were two conventional bottle cages and two water bottles than when there were no bottle holders or cages and no water bottles. This indicates that the two conventional bottle cages and two water bottles caused a measurable amount of air drag against the forward motion of the bicycle. This slows the bicycle down and may be a critical disadvantage in a race.

FIG. 16 also shows an unexpected reduction in air drag for the configuration using the bottle holder system of the present invention. For each of the five wind angles tested, the configuration using the bottle holder system of the present invention and two water bottles provided a significantly lower drag force than the configuration using two conventional bottle cages and two water bottles.

In fact, the configuration using the bottle holder system of the present invention provided similar results to the configuration using no bottle holders or cages and no water bottles. Moreover, for three of the five wind angles tested, the configuration using the bottle holder system of the present invention and two water bottles unexpectedly provided lower drag force than the configuration using no bottle holders or cages and no water bottles.

At a wind angle of 0 degrees, the configuration using the bottle holder system of the present invention and two water bottles provided the lowest drag force of about 645 grams. The configuration using no bottle holders or cages and no water bottles provided a higher drag force of about 660 grams. The configuration using two conventional bottle cages and two water bottles provided a significantly higher drag force of about 685 grams.

At the highest wind angle tested of 20 degrees, the configuration using the bottle holder system of the present invention and two water bottles provided the lowest drag force of about 735 grams. The configuration using no bottle holders or cages and no water bottles provided a slightly higher drag force of just below 740 grams. The configuration using two conventional bottle cages and two water bottles provided a much higher drag force of about 785 grams.

The results of these wind tunnel tests indicate advantages provided by the present invention in terms of reducing air drag relative to a configuration of using two conventional bottle cages and two water bottles. These advantages were present in all five of the wind angles tested, including significant advantages at the lowest (0 degrees) and highest (20 degrees) wind angles tested.

The configuration of the present invention provided somewhat similar results to a configuration using no bottle holders or cages and no water bottles, and in some cases provided slightly better performance. It is understood that the configuration using no bottle holders or cages and no water bottles is not practical for bicycle races, other than short sprints, because a racer will need to hydrate themselves. He or she will generally prefer to carry water bottles on his or her bicycle, instead of relying on others to hand water bottles to them every time they need or want to drink.

### Example 2

Simulated 40 km time trials were conducted using the results of the wind tunnel test from Example 1. Velocity (m/s) and time (s) were calculated for each of the same three configurations, namely:

1. A bicycle which does not have any bottle holders or cages mounted to it. Hence, no water bottles were mounted to the bicycle.
2. A bicycle with two conventional bottle cages mounted to the bicycle, with one cage mounted to the rear side of the down tube and one cage mounted to the front side of the seat tube. Two standard round water bottles were mounted to the bicycle, with one bottle being held in each cage.
3. A bicycle with a preferred embodiment of the bottle holder system of the present invention mounted to it. Two standard round water bottles were mounted to the bicycle, with one bottle held in the first bottle holder and the other bottle held in the second bottle holder.

More specifically, the following calculations were done:
i. The power (in Watts) required to complete a 40 km time trial at 25 mph (11.176 m/s) with the configuration having no bottle holders or cages and no bottles was calculated. This was deemed to be the baseline configuration.
ii. The power calculated from step i was used to calculate the velocity if the rider used: (a) the configuration using two conventional bottle cages and two standard round water bottles; and (b) the configuration using the preferred embodiment of the present invention and two standard round water bottles.
iii. The time taken to travel the 40 km distance between the different configurations was calculated based on the differences in velocity.
iv. The difference in time taken to travel the 40 km distance between the different configurations was calculated based on the differences in time.

The results are shown below in Tables 1 to 5. Each of Tables 1 to 5 set out the calculated velocity (m/s) and time (s) for 40 km time trials for each of the above-mentioned three configurations at different wind angles as follows:

Table 1: 0 degrees (ie. parallel to the plane extending from the front wheel to the rear wheel).
Table 2: 5 degrees.
Table 3: 10 degrees.
Table 4: 15 degrees.
Table 5: 20 degrees.

TABLE 1
40 km Time Trial, Constant Power, Zero Yaw

| | | | Preferred |
|---|---|---|---|
| | No cages | Conventional Cages | Embodiment |
| Velocity (m/s) | 11.176 | 11.08 | 11.14 |
| Power (W) | 328.9 | 328.9 | 328.9 |
| Time (s) | 3579.1 | 3610.6 | 3589.9 |
| Time Difference | baseline | 31.5 | 10.8 |

TABLE 2
40 km Time Trial, Constant Power, 5 Yaw

| | | | Preferred |
|---|---|---|---|
| | No cages | Conventional Cages | Embodiment |
| Velocity (m/s) | 11.176 | 11.12 | 11.25 |
| Power (W) | 325.5 | 325.5 | 325.5 |
| Time (s) | 3579.1 | 3598.4 | 3555.7 |
| Time Difference | baseline | 19.3 | −23.4 |

TABLE 3
40 km Time Trial, Constant Power, 10 Yaw

| | | | Preferred |
|---|---|---|---|
| | No cages | Conventional Cages | Embodiment |
| Velocity (m/s) | 11.176 | 11.10 | 11.17 |
| Power (W) | 320.3 | 320.3 | 320.3 |
| Time (s) | 3579.1 | 3602.9 | 3580.8 |
| Time Difference | baseline | 23.8 | 1.7 |

TABLE 4
40 km Time Trial, Constant Power, 15 Yaw

| | | | Preferred |
|---|---|---|---|
| | No cages | Conventional Cages | Embodiment |
| Velocity (m/s) | 11.176 | 11.06 | 11.18 |
| Power (W) | 322.1 | 322.1 | 322.1 |
| Time (s) | 3579.1 | 3616.3 | 3578.3 |
| Time Difference | baseline | 37.2 | −0.8 |

TABLE 5
40 km Time Trial, Constant Power, 20 Yaw

| | | | Preferred |
|---|---|---|---|
| | No cages | Conventional Cages | Embodiment |
| Velocity (m/s) | 11.176 | 11.04 | 11.17 |
| Power (W) | 322.4 | 322.4 | 322.4 |
| Time (s) | 3579.1 | 3623.9 | 3582.5 |
| Time Difference | baseline | 44.8 | 3.4 |

As can be seen from Tables 1 to 5, the configuration using the preferred embodiment of the bottle holder system of the present invention with two water bottles provided better performance than the configuration using two conventional bottle cages and two water bottles at all five wind angles.

At each wind angle, the configuration using the preferred embodiment provided a higher velocity over the configuration using two conventional bottle cages, especially at wind angles of 5 degrees (Table 2) and 20 degrees (Table 5) where the velocity is higher by 0.13 m/s. The smallest advantage in velocity occurred at a wind angle of 0 degrees (Table 1) where the velocity provided by the preferred embodiment is still higher by a significant 0.6 m/s.

At each wind angle, the configuration using the preferred embodiment also provided substantial time savings in the 40 km trial over the configuration using two conventional bottle cages. For example, at a wind angle of 5 degrees (Table 2), there was a time savings of 42.7 seconds. At a wind angle of 20 degrees (Table 5), there was a time savings of 41.4 seconds. The smallest advantage in time savings occurred at a wind angle of 0 degrees (Table 1) where the preferred embodiment still provided a time savings of 20.7 seconds.

The results of these simulated 40 km time trials indicate advantages provided by the bottle holder system of the present invention with respect to velocity and time saved, particularly when compared to the configuration of using two conventional bottle cages and two water bottles. These advantages were present in all five of the wind angles tested, including at the lowest (0 degrees) and highest (20 degrees) wind angles tested.

There were also cases where the configuration using the preferred embodiment of the bottle holder system of the present invention and two water bottles outperformed the configuration using no water bottles or cages and no water bottles.

At a wind angle of 5 degrees (Table 2), the configuration using the preferred embodiment provided a higher velocity than the configuration using no water bottles or cages and no water bottles by 0.074 m/s. At this same wind angle, the preferred embodiment provided a significant time savings of 23.4 seconds over the configuration using no water bottles or cages and no water bottles.

At a wind angle of 15 degrees (Table 4), the configuration using the preferred embodiment provided a slightly higher velocity than the configuration using no water bottles or cages and no water bottles by 0.004 m/s. At this same wind angle, the preferred embodiment provided a slight time savings of 0.8 seconds over the configuration using no water bottles or cages and no water bottles.

As mentioned above, it is understood that the configuration using no bottle holders or cages and no water bottles is not practical for bicycle races, other than short sprints, because a racer will need to carry water bottles to hydrate themselves.

The scope of the claims should not be limited by the preferred embodiments set forth in the examples, but should be given the broadest interpretation consistent with the description as a whole.

1. A bottle holder system mountable to a bicycle, wherein said bicycle comprises a down tube and a seat tube,
wherein said system comprises:
a first bottle holder, said first bottle holder comprising: (i) a first bottom wall; (ii) a first left side wall extending from said first bottom wall; and (iii) a first right side wall extending from said first bottom wall, wherein said first bottom wall is mountable to a rear side of the down tube of the bicycle, and wherein said first bottom wall, first left side wall and first right side wall form a first interior cavity shaped for receiving a first round bottle;
a second bottle holder, said second bottle holder comprising: (i) a second bottom wall; (ii) a second left side wall extending from said second bottom wall; and (iii) a second right side wall extending from said second bottom wall, wherein said second bottom wall is mountable to a front side of the seat tube of the bicycle, and wherein said second bottom wall, second left side wall and second right side wall form a second interior cavity shaped for receiving a second round bottle;
wherein the down tube, the seat tube and exterior surfaces of said first left side wall, second left side wall, first right side wall and second right side wall cooperate to form an airfoil shape, wherein: (i) the down tube is a leading edge of the airfoil shape; (ii) the seat tube is a trailing edge of the airfoil shape; (iii) the exterior surfaces of the first left side wall and the second left side wall comprise a left side of the airfoil shape; and (iv) the exterior surfaces of the first right side wall and the second right side wall comprise a right side of the airfoil shape.

2. The bottle holder system of claim 1, wherein at least a portion of the exterior surface of the first left side wall and at least a portion of the exterior surface of the second left side wall form a substantially continuous left surface over which air flows without going in between the first left side wall and the second left side wall.

3. The bottle holder system of claim 1, wherein at least a portion of the exterior surface of the first right side wall and at least a portion of the exterior surface of the second right side wall form a substantially continuous right surface over which air flows without going in between the first right side wall and the second right side wall.

4. The bottle holder system of claim 1, wherein lower sections of the second left side wall and the second right side wall of the second bottle holder are nested within lower sections of the first left side wall and the first right side wall of the first bottle holder.

5. The bottle holder system of claim 1, wherein lower sections of the first left side wall and the first right side wall of the first bottle holder are nested within lower sections of the second left side wall and the second right side wall of the second bottle holder.

6. The bottle holder system of claim 1, wherein said first bottle holder further comprises one or more ridges extending into the first interior cavity for securing the first round bottle in position.

7. The bottle holder system of claim 1, wherein said second bottle holder further comprises one or more ridges extending into the second interior cavity for securing the second round bottle in position.

8. The bottle holder system of claim 1, wherein said first bottle holder and said second bottle holder comprise a solid material selected from the group consisting of metal, plastic and carbon fiber.

9. A method for reducing air drag acting against a forward motion of a bicycle, said method comprising providing a bottle holder system mountable to said bicycle, wherein said bicycle comprises a down tube and a seat tube,
wherein said system comprises:
a first bottle holder, said first bottle holder comprising: (i) a first bottom wall; (ii) a first left side wall extending from said first bottom wall; and (iii) a first right side wall extending from said first bottom wall, wherein said first bottom wall is mountable to a rear side of the down tube of the bicycle, and wherein said first bottom wall, first left side wall and first right side wall form a first interior cavity shaped for receiving a first round bottle;
a second bottle holder, said second bottle holder comprising: (i) a second bottom wall; (ii) a second left side wall extending from said second bottom wall; and (iii) a second right side wall extending from said second bottom wall, wherein said second bottom wall is mountable to a front side of the seat tube of the bicycle, and wherein said second bottom wall, second left side wall and second right side wall form a second interior cavity shaped for receiving a second round bottle;
wherein the down tube, the seat tube and exterior surfaces of said first left side wall, second left side wall, first right side wall and second right side wall cooperate to form an airfoil shape, wherein: (i) the down tube is a leading edge of the airfoil shape; (ii) the seat tube is a trailing edge of the airfoil shape; (iii) the exterior surfaces of the first left side wall and the second left side wall comprise a left side of the airfoil shape; and (iv) the exterior surfaces of the first right side wall and the second right side wall comprise a right side of the airfoil shape.

10. The method of claim 9, wherein at least a portion of the exterior surface of the first left side wall and at least a portion of the exterior surface of the second left side wall form a substantially continuous left surface over which air flows without going in between the first left side wall and the second left side wall.

11. The method of claim 9, wherein at least a portion of the exterior surface of the first right side wall and at least a portion of the exterior surface of the second right side wall form a substantially continuous right surface over which air flows without going in between the first right side wall and the second right side wall.

12. The method of claim 9, wherein lower sections of the second left side wall and the second right side wall of the second bottle holder are nested within lower sections of the first left side wall and the first right side wall of the first bottle holder.

13. The method of claim 9, wherein lower sections of the first left side wall and the first right side wall of the first bottle holder are nested within lower sections of the second left side wall and the second right side wall of the second bottle holder.

14. The method of claim 9, wherein said first bottle holder further comprises one or more ridges extending into the first interior cavity for securing the first round bottle in position.

15. The method of claim 9, wherein said second bottle holder further comprises one or more ridges extending into the second interior cavity for securing the second round bottle in position.

16. The method of claim 9, wherein said first bottle holder and said second bottle holder comprise a solid material selected from the group consisting of metal, plastic and carbon fiber.
